(19) United States
(12) Patent Application Publication
(10) Pub. No.: US 2025/0170933 A1
(43) Pub. Date: May 29, 2025

(54) Seat for vehicle and vehicle comprising such a seat

(71) Applicant: RAPIDO, Mayenne (FR)

(72) Inventor: Pierre ROUSSEAU, Saint-Berthevin (FR)

(21) Appl. No.: 18/963,051

(22) Filed: Nov. 27, 2024

(30) Foreign Application Priority Data
Nov. 29, 2023 (FR) 2313256

(51) Int. Cl. B60N 2/34; B60N 2/015; B60N 2/02; B60N 2/28; B60N 2/874; B60N 2/90; B60R 22/18

(52) U.S. Cl. CPC B60N 2/34; B60N 2/02246; B60N 2/2893; B60N 2/874; B60R 22/18; B60N 2/015; B60N 2002/971; B60R 2022/1818

(57) ABSTRACT

A seat (1) for a vehicle, the seat (1) comprising a frame (2) intended to be rigidly attached to a vehicle chassis, a first panel referred to as the seat panel (7) and a second referred to as the backrest panel (8), where the seat panel (7) and the backrest panel (8) are hinged together such that the seat (1) can take at least the following two positions: A sitting position; A sleeping position, the seat (1) further comprising at least a third panel referred to as the extension panel (18), hinged on one side relative to the backrest panel (8), such that: in the sitting position, the extension panel (18) is substantially folded back against the backrest panel (8); in the sleeping position, the extension panel (18) and backrest panel (8) are substantially in line with each other in the longitudinal direction.

### DESCRIPTION

This application relates to the field of passenger transport vehicles, and more specifically to vehicles referred to as motorhomes or caravans, i.e. vehicles that contain a living space.

More precisely, this application relates to a seat for such a vehicle, such that the seat can be converted to provide a sleeping surface, i.e. a surface designed to accommodate at least one user in a sleeping position.

In the motor vehicle sector, vehicles commonly contain one or more seats that comprise a seat and a backrest, the latter able to be reclined at an angle relative to the seat so that a passenger is able to assume a near-horizontal position that is more comfortable than a sitting position. Such seats are commonly found in the front of passenger vehicles and commercial vehicles. However, the position of such seats cannot be fully horizontal, due to the backrest angle being restricted by the presence of the rear seats, and/or the need to maintain sufficient space for a passenger situated in the rear of the vehicle.

Motorhomes or caravans are vehicles that contain a living space, i.e. an area that contains equipment appropriate for a living space, such as a table, a kitchenette and a sleeping area. In particular, such vehicles include motorhomes and caravans. The living space further includes a bench seat, potentially combined with a table, and a sleeping area. Such living spaces are often optimized by the inclusion of a bench seat that converts into a bed in order to provide a sleeping surface.

For this purpose, such living spaces commonly include two benches positioned facing each other, on either side of a table. The table can then be lowered down to the same level as the horizontal parts of the two bench seats, in order to form a substantially flat horizontal surface area intended to be used for sleeping. The bench seat backrest cushions can then be removed to form the mattress for sleeping.

However, converting such a bench seat into a bed is a time-consuming process. Moreover, the bench seat cannot be used as a seat while the vehicle is in motion.

Document CN215621554 describes a vehicle seat that can be converted into a bed by using a handle to pivot the backrest relative to the seat. However, such a solution does not address the problem of the potential space taken up behind the seat backrest. In recreational vehicles, it is common for a seat to be positioned in the living space with its backrest against a wall.

U.S. Pat. No. 3,282,625 describes an example of a vehicle seat that can be converted into a bed, with the seat comprising a sitting surface and a backrest, each covered by a cushion attached to the metal structure of the seat. When in a sitting position, the seat cushion and seat backrest are inclined at an angle to each other, but when in a sleeping position, the seat cushion and backrest are substantially situated in the same horizontal plane. The movement from the sitting position to the sleeping position requires the backrest and seat to pivot relative to each other, and the rotating axle to slide longitudinally between the backrest and seat so that the backrest is moved away from any wall with which it has been in contact in the sitting position. To prevent movement of the seat from the sitting position to the sleeping position while the vehicle is in motion, for example as a result of sudden braking, the seat is locked in the sitting position by means of a locking device. The locking device consists of a notch on the metal structure supporting the seat. The notch is in contact with a bar attached to the vehicle chassis. To release the locking device, in order to move the seat from the sitting position to the sleeping position, the seat must be lifted so that the notch is disengaged from the bar, allowing the seat surface to pivot in relation to the backrest.

This is not an entirely satisfactory solution.

Firstly, the seat size has to compromise between comfort, for a passenger sitting on the seat, and the space requirements within the vehicle, meaning that surface area is limited for both the seat and the backrest. As a result, the sleeping surface area is also limited, as it corresponds to the total of the seat surface and the backrest surface added together. Consequently, this may not provide sufficient space for an adult user to lie down comfortably.

In addition, the locking of the seat in the sitting position is unreliable, since vibrations or jolts on the road can cause the seat to lift up while the vehicle is moving, thus releasing it unintentionally and allowing it to move into the sleeping position.

In document CN215621554 presented above, the seat and backrest each include a support bar that slides across to provide a support for a cushion. This therefore increases the width of the sleeping surface area. Nevertheless, it remains limited in length. In addition, this document shows that the backrest pivots relative to the seat in order to move from the sitting position to the sleeping position, which requires sufficient space available to position the backrest.

The invention therefore aims to provide a solution to at least the abovementioned issues, and in particular to offer a seat that can be extended whilst ensuring that passenger safety will be sufficient whilst the vehicle is in motion.

A first object of the invention is to provide a vehicle seat that can be converted into a bed that offers a comfortable sleeping surface.

A second object of the invention is to provide a vehicle seat that can be converted into a bed that is appropriate for road safety requirements.

A third object of the invention is to provide a vehicle seat that can be converted into a bed that is appropriate for the restricted space available in a motorhome.

A fourth object of the invention is to provide a vehicle seat that can be converted into a bed, which is easy to move from seat position to sleeping position, and vice versa.

A fifth object of the invention is to provide a vehicle seat that can be converted into a bed and can easily be installed inside a vehicle.

In a first aspect, the invention relates to a vehicle seat, also referred to as a bench seat. The seat comprises a frame designed to be rigidly attached to a vehicle chassis, in compliance with current regulations, a first panel referred to as the seat and a second panel referred to as the backrest. The seat panel and backrest panel are hinged together such that they are able to pivot about at least a first rotating axle, which is integral with at least one of the seat panel and backrest panel and extends in a transverse direction, such that the seat can take at least the following two positions:
A sitting position, with the backrest panel and seat panel substantially at right angles to each other;
A sleeping position, with the backrest panel and seat panel substantially in line with each other longitudinally, in such a way as to form a sleeping surface.

More specifically, in the sitting position, the angle between the seat panel and the backrest panel is not exactly equal to 90° but corresponds to the angle required by the regulations and/or recommendations covering vehicle seats.

The seat further comprises a slide system to move the seat panel and backrest panel together longitudinally relative to the seat frame, and a locking system for locking and releasing the slide system, at least when the seat is in the may position. Preferably, when the seat is in the sitting position, the locking system should be able to prevent any movement of the seat panel relative to the frame.

The seat further comprises at least one third panel, referred to as an extension panel, which is hinged on one side relative to the backrest panel, about at least a second rotating axle that extends in a transverse direction, different to the first transverse axle, and on the other side relative to the frame about at least a third transverse axle different to the first transverse axle and the second transverse axle, such that:
In the sitting position, the extension panel is substantially folded back against the backrest panel;
In the sleeping position, the extension panel and backrest panel are substantially in line with each other longitudinally.

When the seat is in the sleeping position, it then forms a bed and can provide a longer reclining length than that provided by the seat panel and backrest panel alone, such that it can offer an improvement in comfort for the user. This does not add to the seat's bulkiness in the sitting position, which remains similar to that presented by the seat and backrest panels alone. This makes the seat particularly suitable for use in motorhomes and caravans.

The seat further comprises at least one seat belt with at least two attachment points. The seat belt comprises at least one belt strap with an end designed to be rigidly attached to the vehicle frame, and at least one hook integral with the strap. The seat belt further includes at least one housing to receive the abovementioned hook, with such housing designed either to be rigidly attached to the seat frame, or to be attached directly to the vehicle chassis.

Due to the seat belt, with attachment points to fix it to the vehicle chassis either directly or by means of the seat frame, the seat can be used in the sitting position while the vehicle is in motion on the road, in compliance with vehicle and road safety regulations.

In various aspects, it is possible to provide one and/or the other of the following features, taken alone or in combination.

According to an embodiment, the seat panel comprises an upper surface, designed to be in contact with a user, and a lower surface. At least one housing can therefore take at least two positions:
A retracted position, in which the housing is located in an area underneath the lower surface of the seat panel;
A hanging position, in which the housing is located at least partly in an area above the lower surface of the seat panel.

In the retracted position, the housing may be located under the seat, in such a way as to avoid getting in the way of a passenger lying on the seat in the sleeping position. According to an embodiment, therefore, the housing is in the hanging position at least when the seat is in the sitting position, and the housing is in the retracted position at least when the seat is in the sleeping position.

In the hanging position, therefore, the housing allows access when the seat is in the sitting position, whilst in the concealed position, the housing can remain outside the area in which the access is located. The housing concealing position is better for implementation, therefore, when the seat is in the sleeping position, preventing any discomfort for the passenger who wishes to lie down.

According to an embodiment, the seat belt can be a three-point belt. The seat may further include a vertical strut, designed to be attached rigidly to the vehicle chassis. The three belt attachment points are then formed on the strut. The belt strap is guided at least partly along the length of the strut. This design facilitates installation of the seat fitted with the seat belt, by attaching the strut to the vehicle chassis. This ensures that the passenger is safe whilst the vehicle is in motion.

The strut can be extended preferably substantially above the backrest panel when the seat is in the sitting position, in such a way as to bring the belt strap into an area easily accessible to a passenger on the seat in the sitting position.

According to an embodiment, the locking system comprises at least one strike plate, which is rigidly attached to at least one of either the seat panel or backrest panel, and which comprises at least one lock rigidly attached to the frame, with the locking system able to take either of two positions:
A locked position, in which the strike plate is kept in the lock, with the seat in the sitting position;
An unlocked position, in which the strike plate is removed away from the lock.

The locking system changes from the locked position to the unlocked position by operation of a locking pin. The locking system is therefore used to offer the ability to lock the seat in the sitting position, in order to prevent any movement of the panels whilst the vehicle is in motion. In particular, the sturdy and reliable strike plate/lock system completely blocks any sliding and/or rotating movement of the seat panels. The seat therefore complies with all safety requirements.

According to an embodiment, the slide system is of the rail type, comprising at least one longitudinal rail on the frame and at least one slide on the seat panel working cooperatively with this rail. The slide system is used to ensure that the longitudinal movement of the panels is achieved effectively.

According to an embodiment, the slider can comprise at least one longitudinal sliding bar mounted on the rail, with the rail able to take at least two positions:
A retracted position, in which a minimal length of the sliding bar extends beyond the rail in the longitudinal direction, with the seat in the sitting position;
A deployed position, in which a maximum length of the sliding bar extends beyond the rail in the longitudinal direction, with the seat in the sleeping position.

The seat panel can be attached to the sliding bar to cause movement between the two seat positions. The bar may be telescopic, for example comprising at least two sections, so as to increase the maximum stroke allowing the seat to be moved into the sleeping position by moving the three panels, at minimum.

According to an embodiment, the seat panel can comprise a plate fitted with hooks to form a safety system, for example of the Isofix and/or I-size type, designed for securing a child seat. The safety system moves with the seat panel, such that there is no interference with the other panels when the seat is moving between its two positions. The safety system allows the seat to be used in exactly the same way as a car seat, in compliance with all safety requirements.

According to an embodiment, the seat may include a lateral extension system, which includes at least one support designed to hold a cushion. The abovementioned support is mounted on at least one of the abovementioned panels, allowing sliding in a transverse direction. The lateral extension system may then take one of at least two positions:
A retracted position in which the support is integrated into the panel on which it is mounted;
A deployed position in which the support is at least partially extended out from the panel on which it is mounted.

The extension system therefore allows the surface area of at least one panel to be increased laterally when the seat is in the sleeping position. In practice, each panel is fitted with a lateral extension system, which can be used to extend the whole of the sleeping surface area laterally.

According to an embodiment, the abovementioned support can be fitted with a pivoting leg designed to be in contact with a vehicle floor when the support is in the deployed position. This makes the seat more robust and more stable when it is in the sleeping position

According to an embodiment, at least one of the seat panel, the backrest panel and the extension panel on which the support is mounted includes a cushion. The retracted support can then be integrated into the cushion of the panel on which the support is mounted. This makes the support invisible in the retracted position, and able to be uncovered easily to change to the deployed position. This improves the appearance of the seat and makes it easier to handle. The preferred position for this installation is on the lower surface of the panel cushions, such that it will not be felt by a user sitting on the seat in the sitting position or lying on the seat in the sleeping position.

According to an embodiment, the lateral extension system can include at least three supports, with each support mounted on one of the seat panel, backrest panel and extension panel.

According to an embodiment, the backrest panel can include at least one headrest. The extension panel can then include a housing with a negative space shaped to match the headrest, so that in the sleeping position the backrest panel headrest is inserted into the extension panel housing. This makes the seat more comfortable in both the sitting position and the sleeping position.

According to an embodiment, the seat can include an actuator to move the seat from the sitting position to the sleeping position and vice versa, with this actuator including at least one electrically-operated cylinder. The actuator cylinder can be supported on one side by means of the frame and on the other side by means of the extension panel. The movement from one position to the other requires no force from the user. The actuator cylinder can potentially be disengaged manually, so that the seat can be moved from one position to the other even in the event of an actuator failure.

According to an embodiment, the seat can include at least a two-point seat belt, and preferably at least a three-point belt, to ensure that the seat can be used whilst the vehicle is in motion, depending on the safety requirements of different countries.

In a second aspect, the invention relates to a vehicle, for example a motorhome or caravan or similar, including at least one seat as described above. The vehicle thus offers the ability to provide a particularly comfortable bed in a confined space, quickly and easily.

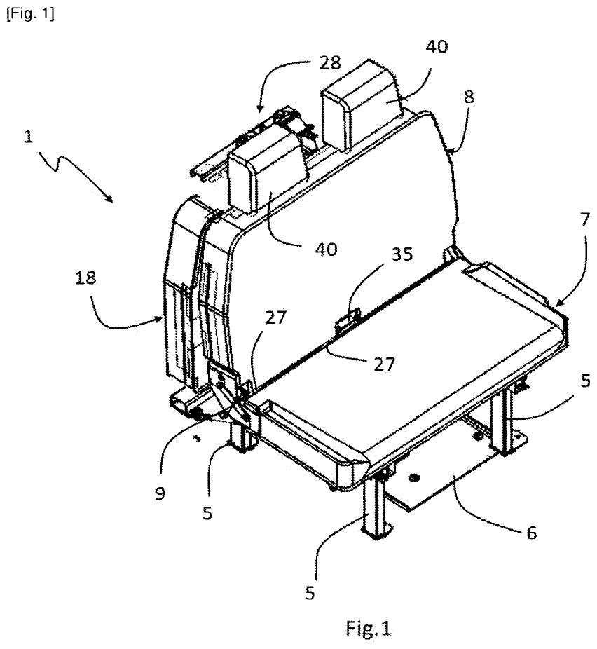

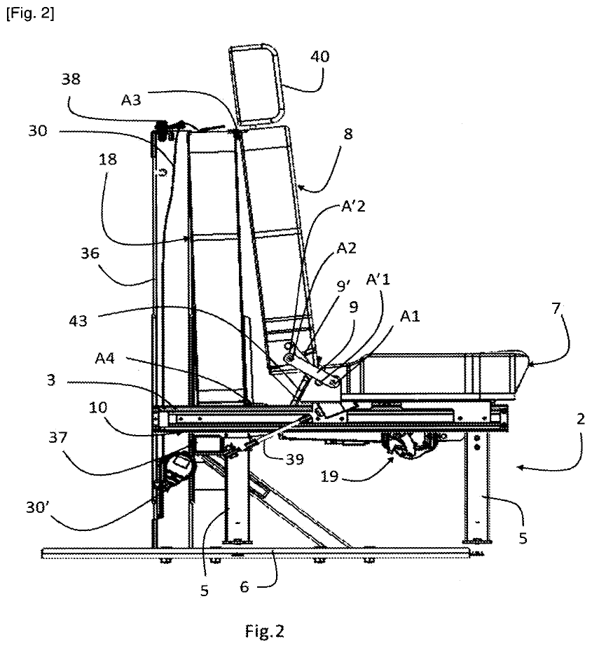

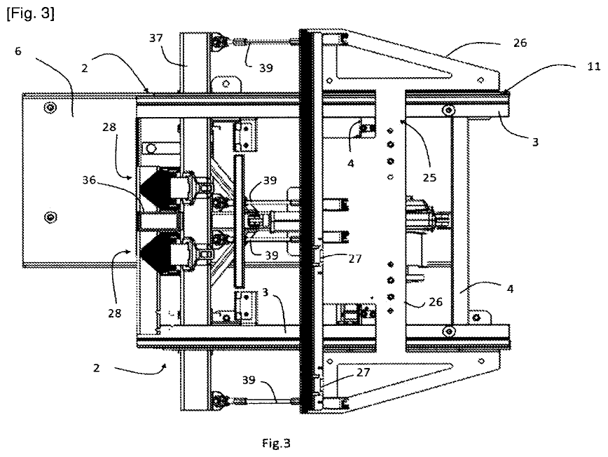

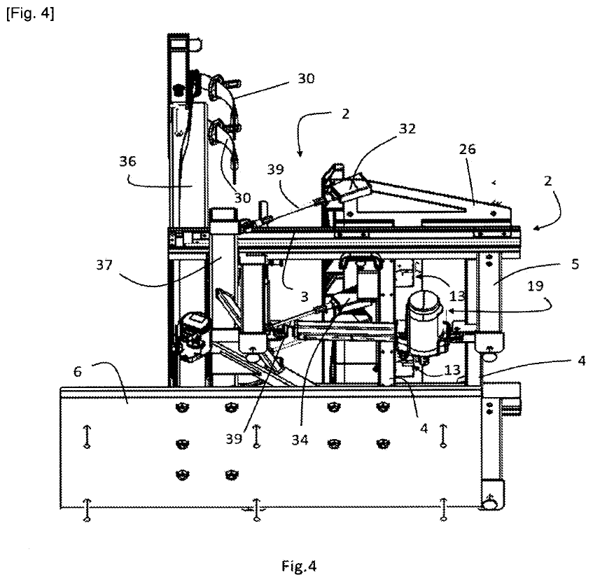

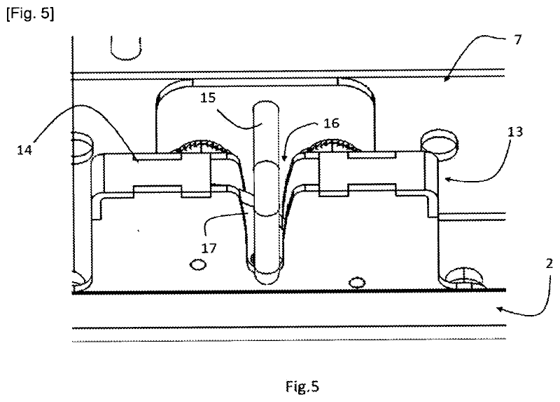

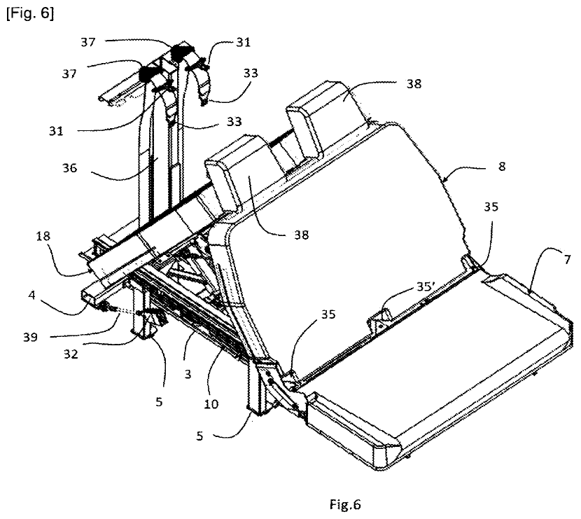

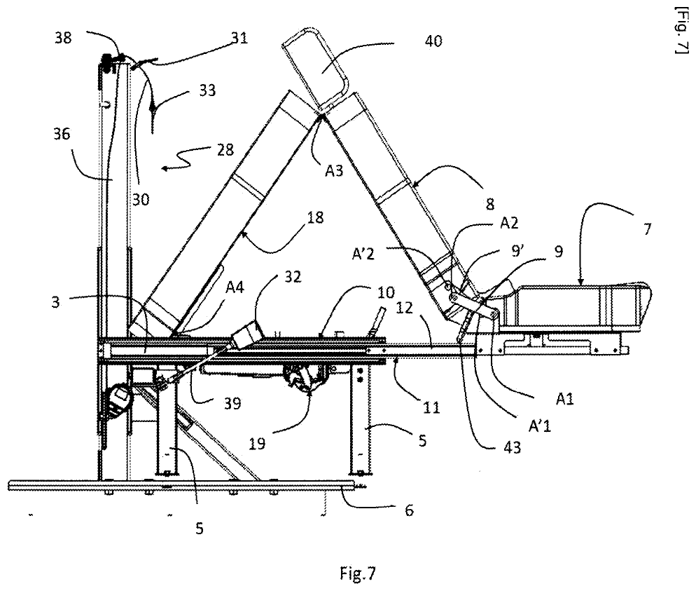

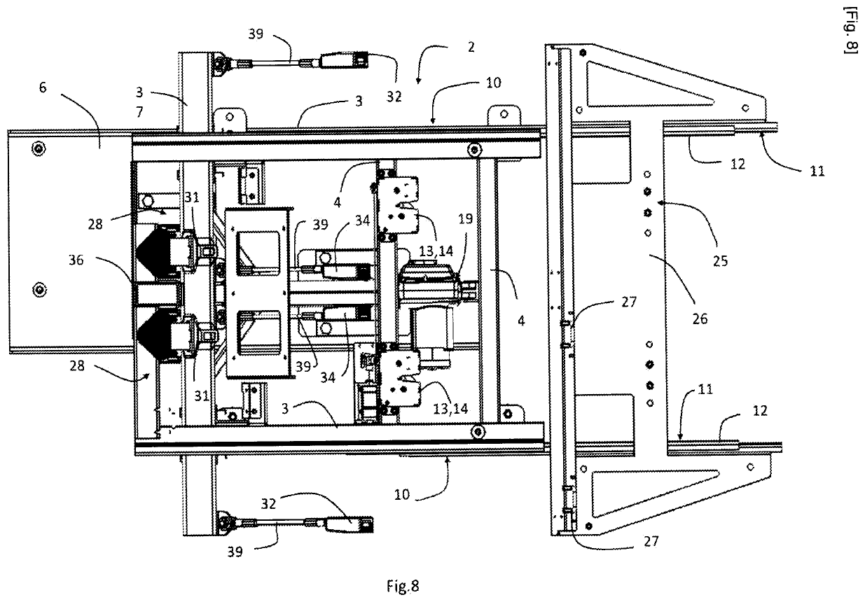

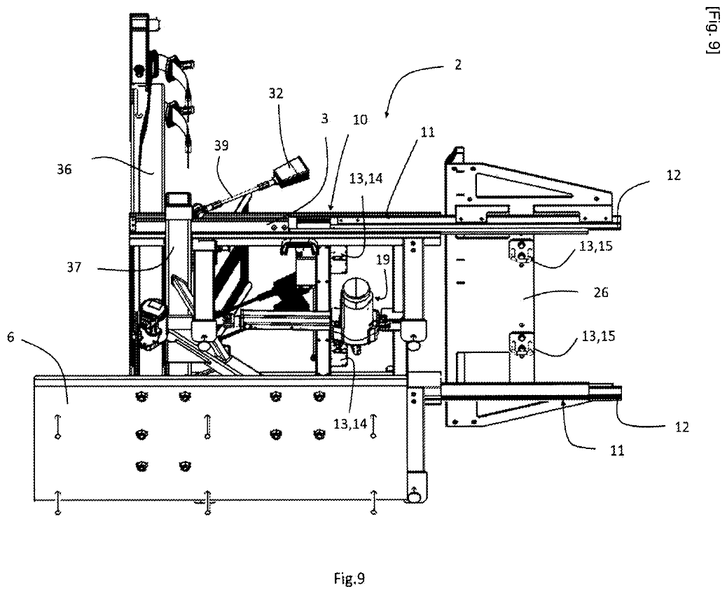

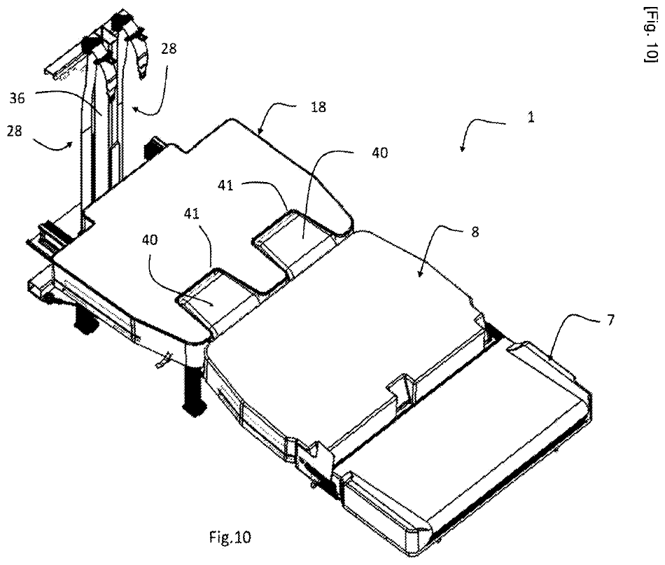

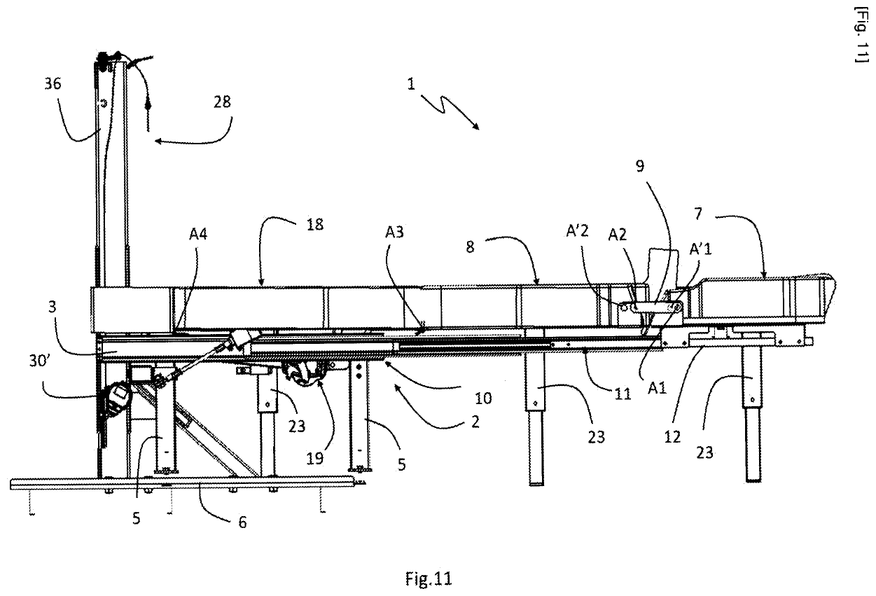

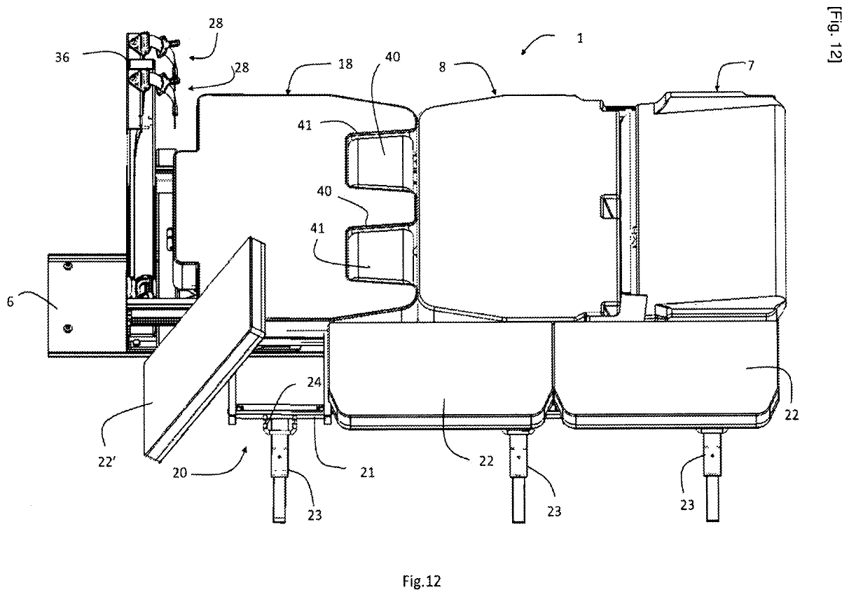

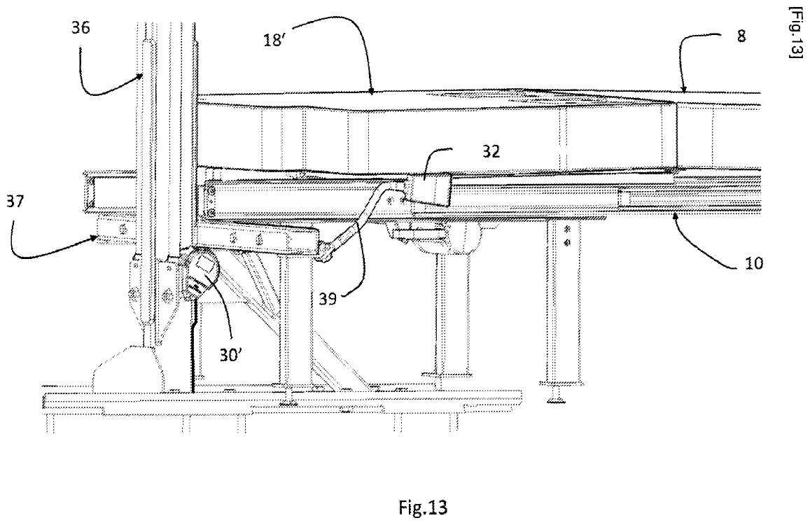

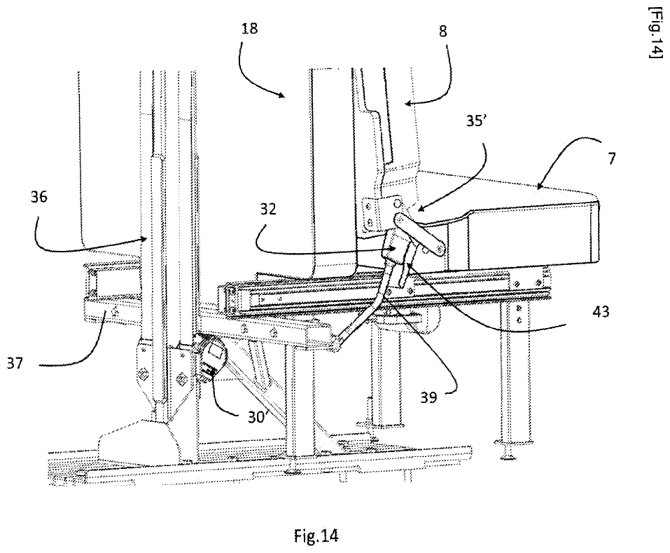

Further implementations of the invention will be described below with reference to the drawings, described briefly below:

[FIG. 1] shows a three-dimensional top view of a vehicle seat that can be converted into a bed, according to an embodiment, in a sitting position.

[FIG. 2] shows a side view of the seat shown in FIG. 1.

[FIG. 3] shows a top view of the seat shown in FIG. 1, with panels removed.

[FIG. 4] shows a three-dimensional bottom view of the seat with panels removed as in FIG. 3.

[FIG. 5] shows a detailed view of a locking system for the seat shown in FIGS. 1 to 4 and 6 to 12.

[FIG. 6] shows a view similar to FIG. 1, with the seat in an intermediate position between the sitting position shown in FIG. 1, and a sleeping position.

[FIG. 7] shows a side view of the seat shown in FIG. 6.

[FIG. 8] shows a top view of the seat shown in FIG. 6, with panels removed.

[FIG. 9] shows a three-dimensional bottom view of the seat of FIG. 7 with panels removed.

[FIG. 10] shows a view similar to FIG. 1 and FIG. 6, with the seat in a sleeping position.

[FIG. 11] shows a side view of the seat shown in FIG. 10, with a lateral extension system in the deployed position.

[FIG. 12] shows a three-quarter top view of the seat shown in FIG. 11.

[FIG. 13] shows a detailed view of a seat belt housing when the seat is in the sleeping position.

[FIG. 14] shows a detailed view of a seat belt housing when the seat is in the sitting position.

Where identical references are used on these drawings, they designate identical or similar objects.

FIGS. 1 to 14 show a seat 1 that can be converted into a bed. The seat 1 is designed specifically to be placed and installed inside a vehicle that includes a living space, in particular a vehicle referred to as a motorhome or recreational vehicle. The vehicle concerned may be a motor vehicle, such as a motorhome, recreational vehicle or camper van, but could also be a different type of item, such as a caravan or trailer. The seat 1 is designed to provide seating for at least one passenger. In the example shown below, the seat is designed to seat at least two passengers.

The seat 1 includes a frame 2 designed to be rigidly attached to a vehicle chassis. Frame 2, for example, is formed by a metal framework, typically comprising at least one, and in practice at least two, longitudinal bars 3, connected by at least one, and in practice at least two, transverse bars 4, and including vertical legs 5, for example four vertical legs, intended to be rigidly attached directly or not to the vehicle chassis, for example to a chassis floor. The frame 2 of the seat 1 may also include a base plate 6, designed to be rigidly attached directly or indirectly to the vehicle chassis floor. The design of the frame 2 and its attachment to the vehicle chassis are compliant with the requirements specified in the motor vehicle sector safety regulations. In particular, the frame 2 of the seat 1 remains attached to the vehicle chassis when under the conditions specified in the regulations.

Below, we define a longitudinal direction running substantially parallel to the longitudinal bars of the frame 2, and a transverse direction substantially perpendicular to the longitudinal direction, with a horizontal plane defined by this longitudinal direction and transverse direction. A vertical direction is also defined as perpendicular to the horizontal plane, and is the extending direction of the legs 5.

Below, we will also use the terms above, below, on, under and any variations thereof in reference to the natural orientation of the seat 1, which is as shown in the illustrations, in which the seat is intended to be attached to a vehicle floor, and this floor is generally substantially parallel to the ground under normal conditions of use.

Below, for reasons of clarity, we also define a forward and a reverse direction in line with the longitudinal direction.

The seat 1 also comprises at least a first panel (seat panel 7) and a second panel (backrest panel 8).

In one implementation, each panel 7 and 8 comprises a rigid frame, for example made of metal or wood, and a cushion attached to the rigid frame. Here, the term “cushion” is generally used to refer to an element that is soft and comfortable for a passenger, and preferably elastic and/or flexible. These parts may be made of foam, for example, or any other filling material able to provide softness, enclosed in a soft cover, such as fabric, plastic or leather. It is preferable for the cover to be removable. The cover may enclose all or part of the rigid frame in order to conceal it.

The seat panel 7 and the backrest panel 8 are hinged together about at least a first substantially transverse rotating axle A1, such that the seat 1 is able to take at least the following two positions:
A sitting position, with the seat panel 7 and the backrest panel 8 substantially at right angles to each other;
A sleeping position, with the seat panel 7 and the backrest panel 8 substantially in line with each other longitudinally, in such a way as to form a sleeping surface.

More specifically, in the sitting position, the angle between the seat panel 7 and the backrest panel 8 is not exactly equal to 90°, but corresponds to the angle required by the regulations and/or recommendations covering vehicle seats.

It is preferable for the seat panel 7 to maintain a substantially horizontal configuration whether in the sitting or the sleeping position. This means that, when the seat 1 is in the sitting position, the seat panel 7 provides a seating surface that a passenger can sit on. In the sitting position, the backrest panel 8 is substantially vertical, so that the passenger sitting on the seat panel 7 can rest his or her back against the backrest. The angle of the backrest panel 8 relative to the seat panel 7 can be adjusted by any known means when the seat is in the sitting position, such that the passenger can adjust the angle to be comfortable for him-or herself. In the sleeping position, the backrest panel 8 becomes substantially horizontal, such that it can provide a surface contiguous to the seating surface of the seat panel 7, i.e. in such a way as to provide a sleeping surface on which the passenger can lie down.

Below, the upper surface of a panel is considered to be the surface intended to be in contact with a user, whereas the lower surface is considered to be the surface opposite the upper surface.

The seat 1 can immediately take any intermediate position between the sitting position and the sleeping position.

The first rotating axle A1 may be integral with the seat panel 7 or the backrest panel 8, or may be common to both the seat panel 7 and the backrest panel 8, such that the first axle A1 moves relative to the frame 2 with the seat panel 7 and the backrest panel 8 when the seat 1 moves from one position to the other.

According to an embodiment, the connection between the seat panel 7 and the backrest panel 8 takes the form of a pantograph-type linkage able to pivot about four different first transverse axles A1, A′1 and A2, A′2 specifically a first axle A1 integral with the seat panel 7 and a first axle A2 integral with the backrest panel 8, connected by at least a first link 9, and a first axle A′1 integral with the seat panel 7 and a first axle A′2 integral with the backrest panel 8, connected by at least a second link 9′, which crosses the first link 9 when the seat 1 is in the sitting position. It is preferable for the first axles A1 and A2, integral with the seat panel 7 and the backrest panel 8 respectively, to be connected by two first links 9 arranged in the transverse direction on each side of the seat panel 7 and backrest panel 8. Similarly, it is preferable for the second axles A′1 and A′2, integral with the seat panel 7 and the backrest panel 8 respectively, to be connected by two second links 9′ arranged in the transverse direction on each side of the seat panel 7 and backrest panel 8. The pantograph-type connection is used to create a space between the seat panel 7 and the backrest panel 8, when the seat 1 is in the sitting position, to allow access to safety systems in particular, as will be seen later.

The seat 1 also includes a sliding system 10 for moving the seat panel 7 and backrest panel 8 relative to the frame 2 in the longitudinal direction. More specifically, the sliding system 10 allows the seat panel 7 and backrest panel 8, as well as at least one first rotating axle A1, to be moved integrally relative to the frame 2, and therefore relative to the vehicle chassis.

According to an embodiment, the seat panel 7 has only one degree of freedom relative to the frame 2, specifically a degree of freedom allowing it to slide in the longitudinal direction. The seat panel 7 therefore includes a seating plane that remains substantially parallel to the sliding plane when the sliding system 10 is actuated to move the seat from one of its positions to the other. In other words, the seat panel 7 does not pivot relative to the frame 2.

According to an embodiment, the sliding system 10 is of the rail type. More specifically, the sliding system 10 may comprise a slider or rail rigidly attached to the frame 2. For example, each longitudinal bar 3 of the frame 2 takes the form of a C-rail, to be able to receive a slider 11 of the sliding system 10, with the slider 11 rigidly attached to a lower surface of the seat panel 7. For example, the slider 11 comprises at least a sliding bar 12, which fits into a rail formed on a longitudinal bar 3 of the frame 2. In practice, the slider 11 comprises two sliding bars 12, each of which is inserted into a rail formed on a longitudinal bar 3 of the frame 2. This allows each sliding bar 12 to take at least two positions:
A retracted position, in which the minimum length of sliding bar 12 extends beyond the rail in the longitudinal direction, with seat 1 in the sitting position.
A deployed position, in which the maximum length of sliding bar 12 extends beyond the rail in the longitudinal direction, with the seat 1 in the sleeping position.

The off-rail length here refers to the longitudinal dimension of the portion of the sliding bar 12 that extends beyond a rail formed on a longitudinal bar 3 of the frame 2. In other words, this concerns the longitudinal dimension of the portion of the sliding bar 12 that projects over a longitudinal bar 3 of the frame 2. The projection may be reduced or eliminated, for example by resting the end of the sliding bar 12 on a vehicle component, such as a platform of another seat opposite the seat 1.

By using the sliding system 10 to actuate the longitudinal displacement of the seat panel 7 relative to the frame 2, the seat 1 can be moved from the sitting position to the sleeping position, and vice versa. A forward longitudinal direction is typically chosen to correspond to the direction in which the sliding movement takes place to move from the sitting position to the sleeping position; the reverse direction is the direction in which the sliding movement takes place to move from the sleeping position to the sitting position.

As will be explained later, each sliding bar 12 can be telescopic, in order to achieve the highest possible maximum off-rail length of the sliding bar 12, i.e. in the deployed position. For this reason, each sliding bar 12 may comprise two, three or more sections that can slide in relation to each other, with the seat panel 7 attached to the section with the greatest travel during longitudinal displacement relative to the frame 2.

According to an embodiment, in order to facilitate the kinematics of movement between the sitting position and the lying position, at least one first rotating axle is mounted in such a way as to be able to slide in the longitudinal direction relative to the frame 2. More specifically, in the example shown in the figures, the axle A1 formed on the seat panel 7 is mounted in such a way as to be able to slide in the longitudinal direction relative to the frame, to the exclusion of any other degree of freedom relative to the frame 2, so that the seat panel 7 maintains a substantially horizontal position during movement of the slider 11 between the various positions of the seat 1.

The seat 1 also includes a locking system 13 for locking and unlocking the sliding system 10, at least when the seat 1 is in the sitting position. When the seat 1 is in the sitting position, it is useful to be able to use it while the vehicle is in motion, like a conventional passenger seat, i.e. in particular while the vehicle is moving along a road. The movements of the vehicle on the road, as well as accelerations and decelerations, can cause the slider 11 to slide along the rails of the frame 2, accidentally moving the seat 1 into the sleeping position. This creates a considerable risk of injury to any passenger sitting in seat 1 at the time. Even when there are no passengers present, the unexpected movement of seat 1 into the sleeping position can damage the vehicle interior. The locking system 13 therefore prevents the seat moving from the sitting position to the sleeping position unless a user takes action to cause this intentionally.

According to an embodiment, the locking system 13 comprises a lock-type element 14 rigidly attached to the frame 2 and a strike plate component 15 rigidly attached to either the seat panel 7 or the backrest panel 8, underneath the lower surface. In the example shown in the illustrations, the strike plate is attached to the lower surface of the seat panel 7. More specifically, according to an embodiment, the lock 14 comprises an opening 16 into which the strike plate 15 can be inserted by sliding longitudinally. The lock 14 also includes a pin 17 that can be operated to block the opening 16 or to leave it clear. The pin 17 is under elastic strain in the position in which it blocks the opening 14. The locking system 13 can take one of two positions:
A locked position, in which the strike plate 15 is blocked in the lock 14, in this case in the opening 16 of lock 14, with seat 1 in the sitting position.
An unlocked position, in which the strike plate 15 comes out from the lock 14, in this case from the opening 16 of the lock 14.

The locking system 13 changes from the locked position to the unlocked position by means of action on the locking pin 17 to clear the opening 16 and allow the strike plate 15 to come out.

When the seat 1 is in the sitting position therefore, the strike plate 15 is in the opening 16 of the lock 14, and is blocked by the pin 17. To move the seat 1 into the sleeping position, for example, an actuator is engaged by a user to unlock the locking system 13. The seat panel 7 and backrest panel 8 are then free to move forwards longitudinally by means of the sliding system 10. Once the actuator has been released, the pin 17 is once again in the position in which it blocks the lock opening 16. To return the seat 1 to the sitting position, the seat panel 7 and backrest panel 8 are moved backwards by means of the sliding system 10, until the strike plate 15 comes to rest against the pin 17. The pin 17 is then moved, either by operating the actuator, or by pressing on the pin 17 with the strike plate 15. The shape of the pin 17 is designed to cause the pin 17 to move against the elastic strain, to clear the opening 16 of lock 14. The pin 17 returns to its position blocking the opening 16 as soon as the strike plate 15 has passed the pin 17 during the movement backwards.

Finally, the seat 1 includes at least a third panel 18, referred to as extension panel 18, used to make the sleeping surface longer. More specifically, the extension panel 18 is hinged on one side relative to the backrest panel 8 about at least a second transverse rotating axle A3, separate from the first transverse axle or axles A1, A2, A′1, A′2 extending in the transverse direction, and on the other side relative to the frame 2 a third rotating axle A4 extending in the transverse direction different to the first rotating axle A1 and the second rotating axle A3, such that:
In the sitting position, the extension panel 18 is substantially folded back against the backrest panel 8;
In the sleeping position, the extension panel 18 and the backrest panel 8 are substantially in line with each other longitudinally.

In other words, the angle between the backrest panel 8 and the extension panel 18 can be 0° substantially in the sitting position and 180° substantially in the sleeping position.

In the sleeping position, therefore, the total length corresponding to the sleeping length is made up of the three panels 7, 8 and 18. This increased length makes it more comfortable for a user to lie down on seat 1 in the sleeping position. More specifically, when the seat panel 7 is moved using the sliding system 10, the angle between the extension panel 18 and the backrest panel 8 changes, as the seat folds. The position of the extension panel 18 is therefore guided by the sliding of the seat panel 7.

Similarly to the first rotating axle A1, the second rotating axle A3 may be integral with the backrest panel 8 or the extension panel 18 or may be common to both the seat panel 7 and the backrest panel 8, in such a way that the second axle A3 moves relative to the frame 2 with the backrest panel 8 and the extension panel 18 when the seat 1 moves from one position to the other. The hinged joint between the backrest panel 8 and the extension panel 18 can also be achieved by a pantograph-type connection, i.e. by use of multiple second axles.

According to an embodiment, the third axle A4 is common and is rigidly attached to the frame 2 of seat 1 and to the extension panel 18, in such a way that the third axle A4 does not move when the seat 1 moves from one position to the other. In other words, the panels 7, 8 and 18 of seat 1 are not free to move longitudinally relative to frame 2: the maximum travel for deployment of panels 7, 8 and 18 is limited by the rigid attachment between extension panel 18 and frame 2 achieved by the third axle A4. In particular, the presence of such a rigid attachment between panels 7, 8 and 18 and frame 2 limits dangerous movements between panels 7, 8 and 18 of seat 1 and the vehicle chassis, for the safety and comfort of passengers.

In a similar way to the seat panel 7 and backrest panel 8, the extension panel 18 may comprise a rigid frame, particularly where this is made of metal, to which a cushion is attached.

According to an embodiment, the second rotating axle A3 is formed by a hinge-type element, rigidly attached on one side to the rigid frame of the backrest panel 8 and on the other side to the rigid frame of the extension panel 18. It is preferable for the hinge to be attached underneath the lower surface of each of panels 8 and 18.

According to an embodiment, the seat 1 includes a component referred to as a position actuator, which may be electrically-operated, for example, used to move the seat 1 from the sitting position to the sleeping position and vice versa by means of the sliding system 10. In the example shown, the position actuator comprises at least one electrically-operated actuator 19, supported on the frame 2 on one side and on the extension panel 18 on the other side, under the lower surface, and more specifically on the rigid frame of the extension panel 18, in such a way as to pivot the extension panel 18 relative to the frame 2 about the third axle A4. Rotation of the extension panel 18 about the third axle A4 relative to the frame, in one direction or another, therefore causes forward or backward longitudinal movement of the seat panel 7 and the backrest panel 8 relative to the frame 2 by means of the sliding system 10, so that the seat moves from one position to the other. According to an embodiment, the position actuator is combined with the actuator of the locking system 13: when it is used, it can cause the safety system 13 to unlock and the sliding system 10 to be operated at the same time. The actuator comprises a control button (not shown) that can be accessed from inside the vehicle, for example near seat 1. It is preferable for the actuator button to be located on a wall inside the vehicle, at a height that reduces the risk of a child pressing it.

When the seat 1 is in the sitting position, locking system 13 is in the locked state. The actuator is used to move into the sleeping position. According to an embodiment, the actuator is operated by engaging the control button, which controls both the change of the locking system 13 into the unlocked position and the exertion of a thrust force between the frame 2 and the extension panel 18 by the actuator 19, to cause rotation of the extension panel 18 about the third axle A3. The seat panel 7 is then moved forwards along the rails on the longitudinal bars 3 of the frame 2, with the strike plate 15 moving out from the lock 14, until the sliding bars 12 reach their point of maximum travel, bringing the slider 11 into the deployed position. At the same time, the backrest panel 8 and the extension panel 18 follow the sliding of the seat panel 7, with the angle between the backrest panel 8 and the extension panel 18 opening up to approximately 180°. Seat 1 is then in the sleeping position.

When the seat 1 is in the sleeping position, the actuator can be operated again by engaging the control button, which makes the actuator 19 exert a tensile force between the frame 2 and the extension panel 18, to pivot the extension panel 18 about the third axle A3, in such a way as to effect a backward movement of the seat panel 7. At the same time, the angle between the backrest panel 8 and the extension panel 18 narrows to approximately 0°. The strike plate 15 moves into the lock opening 16, and is blocked by the pin 17: the locking system 13 moves into the locked position when the seat 1 reaches the sitting position.

Actuator 19 is automatic: once the control button has been pressed to move seat 1 to one position or another, no further intervention is required. However, in addition to the automatic actuator 19, or as an alternative option, the seat 1 can also include a manual actuator that allows a user to move the seat into one or the other position by manually unlocking or locking the locking system 13, and manually exerting the pushing or pulling force on the seat panel 7 to move it along the rails of the longitudinal bars 3 of the frame 2. For example, the actuator 19 can be disengaged manually, such that the position of seat 1 can be changed manually, for example in the event of a power failure to actuator 19, or any other type of fault.

According to an embodiment, the seat 1 also includes a lateral extension system 20, which can provide a transverse increase in the sleeping surface dimensions. The lateral extension system 20 is linked with at least one of the seat panel 7, the backrest panel 8 and the extension panel 18. According to an embodiment shown here, the lateral extension system 20 is linked with each of the panels 7, 8 and 18. The extension system 20 therefore includes three supports 21. Each support 21 is rigid, for example made of metal, and is mounted with the ability to slide in the transverse direction relative to the panel 7, 8 or 18 with which it is linked, on the same transverse side of the seat 1. More specifically, each support 21 is mounted with the ability to slide relative to the rigid frame of the panel 7, 8 or 18 with which it is linked, such that the lateral extension system 20 can take two positions:
A retracted position in which each support 21 is integrated into the panel 7, 8 or 18 on which the support is mounted;
A deployed position in which each support 21 is at least partially extended out from the panel on which it is mounted.

For example, in the retracted position, the support 21 is integrated into the cushion of panel 7, 8 or 18 on which it is mounted, i.e. it is enclosed by the cover. For this reason, the cover comprises an opening that can be closed and opened again, for example by means of a zip, along one side edge of the cushion of panel 7, 8 or 18, with support 21 emerging from the panel through the abovementioned opening in the cover. It is preferable for the support 21, in the retracted position, to be located on the lower surface of the cushions, i.e. to be covered on top by the cushion pad, such that a passenger sitting or lying on the upper surfaces of the panels 7, 8, 18 of the seat 1 do not feel the supports 21 in the retracted position.

Each support 21 in the deployed position can be covered by a cushion 22 or 22′, which is placed on the support 21. As an optional alternative, the cushion 22, 22′ can be temporarily attached to the support 21. The cushions 22 can be stored, for example, in a dedicated vehicle storage area close to the seat 1.

Each support 21 can include a pivoting leg 23 designed to be in contact with the vehicle floor, when the support is in the deployed position. The leg 23 makes the support 21 more stable. More specifically, the leg 23, for example, is mounted with the ability to pivot on the longitudinal arm of the U-shaped support 21, about a substantially longitudinal axle, such that it can be folded in the same plane as the U of the support and integrated into the panel 7, 8 or 18 when the support 21 is in the retracted position.

From the sleeping position of seat 1, and the retracted position of the lateral extension system 20, a user can manually slide each support 21 in the lateral direction, if necessary after opening the cushion cover, to move them into the deployed position. For this reason, each support 21 can be fitted with a handle 24 on the longitudinal arm of the U, facilitating handling by the user: the user grips the handle 24 and pulls it to slide the support 21 into the deployed position. The user can then unfold the legs 23 to bring them into contact with the floor. Finally, the user places the cushions 22, 22′ on the supports 21.

Each cushion 22, 22′ can be placed on a single support 21, or two or more overlapping supports 21. According to an embodiment, a cushion 22 is positioned straddling the support 23 linked with the seat panel 7 and the support 23 linked with the backrest panel 8, and a second cushion is positioned straddling the support 23 linked with the seat panel 7 and the support 23 associated with the extension panel 18, and a third cushion 22′ is positioned straddling the support 23 linked with the extension panel 18. The third cushion 22′ can be partially projecting over the support 23 linked with the extension panel 18, such that it can be fitted with a retractable leg (not shown) to rest on the vehicle floor and limit the overhang.

The seat 1 therefore offers an increase in lateral surface area both longitudinally, in particular with use of the extension panel 18, and transversely, with use of the lateral extension system 20. One or more users can therefore lie down on the sleeping surface provided by seat 1, in stability and comfort.

In one example, the width of seat 1, i.e. the maximum transverse dimension of the seat panel 7 or backrest panel 8 or extension panel 18, may correspond to one, two or three seats. It can be between 600 and 1500 mm (millimeters), or more precisely between 650 and 1300 mm, or even more precisely between 830 and 930 mm, and it is, for example, equal to 880 mm. In the sleeping position, the overall length of seat 1, i.e. the sum of the longitudinal dimensions of the seat panel 7, backrest panel 8 and extension panel 18 end-to-end, is suitable for an adult man to sleep on. It may be between 1650 and 2250 mm, or more precisely between 1700 and 2200 mm, and it is, for example, equal to 1930 mm. The width of the lateral extension system 20, i.e. the maximum transverse dimension of the cushions 22, 22′, allows the sleeping surface to have a total width between 800 mm and preferably at least 1700 mm, and even more preferably between 1000 and 1500 m, and it is, for example, equal to 1250 mm.

According to an embodiment, the seat 1 can include a safety system 25, for example of the Isofix or I-size type, used to attach a child seat or car seat. The safety system 25, for example, is held by the seat panel 7, and comprises a plate 26 rigidly attached to the seat panel 7 on the lower surface. The plate 26 comprises some means for securing a child seat in accordance with the Isofix or I-size system, with such means accessible to a user from the upper surface of the seat and backrest panels 7, 8, when the seat 1 is in the sitting position. For example, plate 26 includes hooks 27 available between seat panel 7 and backrest panel 8, for a user when seat 1 is in the sitting position. The hooks 27 can be used to attach a child seat in the conventional way, as with any Isofix system. The safety system 25 then moves with the seat panel 7 when the seat 1 moves from one position to another. The strike plates 15 of locking system 13 can be supported by the plate 26 of safety system 25. The attachment of plate 26 to seat panel 7 is compliant with Isofix safety requirements. The movement between the seat panel 7 and backrest panel 8, obtained by means of links 9, 9′ and the first axles A1, A2, A′1 and A′2 described above makes it possible to maintain a gap between the seat panel 7 and the backrest panel 8 when the seat 1 is in the sitting position, so that the hooks 27 are accessible.

The seat 1 can thus provide a comfortable sleeping surface in the sleeping position. However, such kinematics between the sleeping and sitting positions may pose a challenge to allow use of the seat 1 whilst the vehicle is in motion.

According to an embodiment, the seat 1 is equipped with at least one seat belt 28. In the example shown in the illustrations, the seat 1 is equipped with two seat belts 28, and in the sitting position, it can accommodate two passengers.

The seat belt 28 has at least two attachment points, and preferably three, in compliance with road safety regulations, with the number of attachment points on a seat belt corresponding to the number of attachment points on the vehicle chassis. The seat belt 28 therefore has at least two attachment points on the seat frame 2, which is itself rigidly attached to the vehicle chassis.

Each seat belt 28 includes a strap 30, one end of which is rigidly attached to the vehicle chassis either directly or via the frame 2. The attachment of the strap 30 to the frame 2 forms a first attachment point for attaching the belt 28 to the vehicle chassis. The belt 28 then comprises a first hook integral with the strap 30. The belt 28 further comprises a first housing for receiving the first hook, rigidly attached directly to the vehicle chassis or via the frame 2 in such a way as to form the second attachment point of the belt 28 to the vehicle chassis. The housing is used to lock the first hook into the housing and to unlock it. It is preferable for locking and unlocking to be done manually. The length of strap 30 from the end attached to the chassis and the first hook can be adjustable to suit the user's shape and size, for example with use of a retractor. The two attachment points of the belt 28 are arranged such that, when the first hook is engaged in the first housing, the belt strap holds a user onto the seat 1. It is preferable for each attachment point of the seat belt 28 to be positioned underneath the lower surface of the panels 7, 8 and 18 when the seat 1 is in the sleeping position, in order to avoid impeding the movement of seat 1 from the sitting position to the sleeping position and vice versa.

According to an embodiment, shown in the illustrations, the seat 1 comprises two seat belts 28, each with three attachment points. Each belt 28 comprises a strap 30, linked at one end to a reel 30′. The reel 30′ is attached to the frame 2 of the seat 1, in compliance with the requirements of safety regulations. In this way, the reel 30′ can be rigidly attached to the frame 2. Each belt 28 further comprises a first hook 31 that slides along the length of the strap 30 and includes a first housing 32 for receiving the first hook 31. The seat belt 28 further comprises a second hook 33 at the free end of the strap 30 and a second housing 34 for receiving the second hook 33. The first housings 32 are arranged on each side of the seat 1 in the transverse direction, in such a way as to be available for each passenger. A lateral cutout 35 is implemented on each side, in the transverse direction, on the backrest panel 8, in order to position the first housing 32 of each belt 28 on each side of the backrest panel 8 when the seat 1 is in the sitting position, whilst leaving them accessible to users, between the seat panel 7 and the backrest panel 8, when the seat 1 is in the sitting position for the road. The first housings 32 and the second housings 34 are rigidly attached to the seat frame 2, as will be described later. A central cutout 35′ on the backrest panel 8 allows the second housings 34 to be positioned at least partly inside the volume of the backrest panel 8, whilst ensuring that they are still accessible to users, between the seat panel 7 and the backrest panel 8, when the seat 1 is in the sitting position for travelling.

More specifically, the frame 2 of the seat 1 comprises a substantially vertical strut 36, i.e. intended to extend substantially perpendicularly to the floor of the vehicle in which the seat 1 is assembled. The strut 36 may be common to both seat belts 28. A crossbar 37 is rigidly attached to the strut 36. Housings 32 and 34 are mounted on the crossbar 37: the first housings 32 are each mounted on a portion of the crossbar 37 projecting in a transverse direction beyond a longitudinal bar 3 of the frame 2; the second housings 34 are mounted in a central region of the crossbar 37. The strap 30 of each belt 28 is mounted along the length of the vertical strut 36 rigidly attached to the vehicle chassis, from its reel 30′, which can then be attached to the strut 36. The strut 36 supports a guide 38, used to guide the unwinding of the strap 30. In particular, the strut 36 is used to guide the strap 30 over the backrest panel 8 when the seat 1 is in the sitting position. A user can therefore take hold of the strap 30 of a seat belt 28, unwind the strap 30 until the first hook 31 is attached in a first housing 32, then adjust the length of the strap 30 and the position of the second hook 33 along the length of the strap 30 in such a way as to hook the second hook 33 into the second housing 34.

According to an embodiment, the housings 32, 34 can be moved between two positions:
A retracted position, in which the housings 32, 34 are located in an area beneath the lower surface of the seat panel 7;
A hanging position, in which the housings 32 and 34 are located at least partly in an area above the lower surface of the seat panel 7.

More specifically, the lower surface of the seat panel 7 defines an substantially horizontal plane that divides the environment close to the seat 1 into two areas: one area located underneath the lower surface of the seat panel 7, i.e. an area defined between the vehicle floor and the lower surface of the seat panel 7, and the area opposite, located above the lower surface of the seat panel 7.

These two positions of the housings 32 and 34 are used to move the seat 1 from the sitting position to the sleeping position, and vice versa, without stopping operation of the sliding system 10, and whilst maintaining the housings 32 and 34 still within an area with lateral boundaries formed by the seat panel 7. In particular, housings 32 and 34 are in the hanging position when seat 1 is in the sitting position. According to an embodiment, when the seat 1 is in the sitting position and cut-outs 35 and 35′ are applied to the backrest panel 8, the housings 32 and 34 are accessible by means of the cut-outs 35, 35′, between the seat panel 7 and the backrest panel 8. When the seat 1 is in the sleeping position, the housings 32 and 3 are in the retracted position, such that a passenger lying on the seat 1 in the sleeping position will not be inconvenienced by the housings underneath the seat panel 7. Furthermore, in the retracted position, the housings 32 and 34 are released outside of the trajectory of the panels 7, 8, 18 and the sliding system 10. It is therefore preferable for the housings 32 and 34 to be in the retracted position during movement of seat 1 between its positions.

When the seat 1 is moved from the sitting position to the sleeping position, the housings 32 and 34 can be moved from the hanging to the retracted position at the same time; conversely, when the seat 1 is moved from the sleeping position to the sitting position, the housings 32 and 34 can be moved from the retracted position to the hanging position at the same time. For example, at least one of the housings 32 and 34, and preferably each of the housings 32 and 34, on the seat belts 28, is attached to the crossbar 37 by means of a flexible rod 39. More precisely, each flexible rod 39 is rigidly attached, at one of its ends, to the seat frame 2 at the appropriate attachment point, in the area underneath the panels 7, 8, 18 when the seat 1 is in the sleeping position. A housing 32 and 34 is mounted on the other end of each flexible rod 39. Each rod 39 is referred to as flexible, since it presents sufficient flexibility at least to allow deformation without breaking when the seat 1 changes position. In particular, in the sitting position, no force is exerted by panels 7 and 8 on the housings 32 and 34. As the seat begins to move into the sleeping position, the backrest panel 8 can press on the housings 32 and 34 in such a way as to bend the rods 39 and guide the housings into the retracted position. As deployment of the seat 1 continues to move as far as the sleeping position, the extension panel 18 can exert force in turn on the housings 32 and 34, in such a way as to maintain them in the retracted position, so that they do not interfere with a user lying on the seat in the sleeping position (FIG. 13). When seat 1 moves from the sleeping position to the sitting position, the reverse movement engages the housings in the hanging position, no later than when seat 1 reaches the sitting position.

According to an embodiment, the attachment point of each rod 39 to the frame 2 is located underneath the lower surface of the panels 7, 8 and 18 when the seat 1 is in the extended position, whilst still allowing movement of the housings 32 and 34. This reduces the space required on the sides of the seat.

According to an embodiment, the rods 39 can be elastically flexible, such that where there is no force on the housings 32 and 34, they return to a specified initial position, which is the one that allows them to be accessed by a user on the seat 1 in the sitting position. As an alternative, or in combination with the elastic flexibility of a rod 39 of a housing 32 or 34, at least one guide 43 can be attached to either the seat panel 7 or the backrest panel 8, by the corresponding cut-out 35 or 35′ when the seat 1 is in the sitting position. Such a guide 43 functions as a ramp into which the housing 32 and 34 can slide when the seat 1 moves from the sleeping position to the sitting position in order to bring the housing back to the level of the corresponding cut-out 35 or 35′ and give users access to it when the seat 1 is in the sitting position. There may be as many guides 43 as there are housings 32 and 34, with each guide 43 dedicated to a housing 32 or 34. Alternatively, a guide 43 can be formed as a single part that can extend transversely to guide all the housings 32 and 34 (FIG. 14).

In this configuration, the attachment points for each seat belt 28 are attached to the frame 2 of the seat 1, making it easier to install the seat 1 fitted with seat belts 28 in the vehicle, whilst guaranteeing user safety. More precisely, the strut 36, due to the attachment of the housings 32 and 34 in particular, by the flexible rods 39, the housings 32 or 34 remain under the panels 7, 8, 18 when the seat 1 is in the sleeping position, offering no discomfort to a user lying on the seat.

According to an embodiment, the backrest panel 8 comprises at least one headrest 40. As shown in the illustrations, the backrest panel 8 comprises two headrests 40. The extension panel 18 can then comprise, for each headrest 40, a corresponding negative shape, or recessed, housing 41 corresponding to the shape of the headrest 40, so that in the sleeping position of the seat 1, each headrest 40 of the backrest panel 8 is inserted into the housing 41 of the extension panel 18. The headrests 40, which provide comfort for users when the seat 1 is in the sitting position, do not cause any inconvenience when the seat 1 is in the sleeping or handling position.

1. A seat for a vehicle, the seat comprising a frame intended to be rigidly attached to a vehicle chassis, a first panel referred to as a seat panel and a second panel referred to as a backrest panel, with the seat panel and the backrest panel hinged together about at least one first rotating axle (A1) integral with at least one of the seat panel and the backrest panel and extending in a transverse direction such that the seat can take at least the following two positions:
a sitting position with the backrest panel and the seat panel substantially at right angles to one another;
a sleeping position in which the backrest panel and seat panel are substantially in line with each other in a longitudinal direction, in such a way as to form a sleeping surface, the seat further comprising a sliding system for integral movement of the seat panel and backrest panel relative to the seat frame in a longitudinal direction, and a locking system for locking and unlocking the sliding system at least when the seat is in the sitting position, the seat being characterized as further comprising at least one third panel referred to as an extension panel, hinged on one side relative to the backrest panel about at least one second rotating axle extending in the transverse direction, different to the first transverse axle, and on the other hand relative to the frame about a third transverse axle different to the first transverse axle and to the second transverse axle, such that:
in the sitting position, the extension panel is substantially folded back against the backrest panel;
in the sleeping position, the extension panel and backrest panel are substantially in line with each other longitudinally.
the seat also comprising at least one seat belt with at least two attachment points, the belt comprising at least one strap with one end designed to be rigidly attached to the vehicle chassis, the abovementioned belt comprising at least one hook integral with the strap and comprising at least one housing for receiving this hook, with the housing designed to be rigidly attached to the vehicle chassis.

2. The seat according to claim 1, wherein the seat panel comprises an upper surface intended to be in contact with a user and a lower surface, and wherein the housing can take at least two positions:
A retracted position, in which the housing is located in an area underneath the lower surface of the seat panel;
A hanging position, in which the housing is located at least partly in an area above the lower surface of the seat panel.

3. A seat according to claim 2, wherein the housing is in the hanging position at least when the seat is in the sitting position, and the housing is in the retracted position at least when the seat is in the sleeping position.

4. A seat according to claim 1, in which the seat belt is a three-point seat belt, the seat further comprising a vertical strut intended to be rigidly attached to the vehicle chassis and on which the three belt attachment points are formed, with the strap being guided at least part of the way along the strut.

5. A seat according to claim 1, in which the locking system comprises at least one strike plate rigidly attached to at least one of the seat panel or the backrest panel, and which comprises at least one lock rigidly attached to the frame, with the locking system able to take two positions:
A locked position, in which the strike plate is kept in the lock, with the seat in the sitting position;
An unlocked position, in which the strike plate is moved away from the lock;
Wherein the locking system changes from the locked position to the unlocked position by operation of a locking pin.

6. A seat according to claim 1, in which the sliding system comprises at least one longitudinal rail on the frame and at least one slider on the seat panel cooperating with this rail.

7. The seat according to claim 6, in which the rail comprises at least one longitudinal sliding bar mounted with the ability to slide, on the rail, and the rail able to take at least two positions:
a retracted position, in which a minimum length of the sliding bar extends beyond the rail in the longitudinal direction, with the seat in the sitting position;
a deployed position, in which a maximum length of the sliding bar extends beyond the rail in the longitudinal direction, with the seat in the sleeping position.

8. A seat as in claim 1, in which the seat panel comprises a plate fitted with hooks to form a safety system, for example of the Isofix and/or I-size type, designed for securing a child seat.

9. A seat according to claim 1, comprising a lateral extension system, which comprises at least one support intended to support a cushion, with the support mounted with the ability to slide on at least one of these panels in a transverse direction, and the lateral extension system being able to take at least two positions:
a retracted position in which the support is integrated into the panel on which it is mounted;
a deployed position in which the support is at least partially extended out from the panel on which it is mounted.

10. The seat according to claim 9, in wherein said support is equipped with a pivoting leg intended to be in contact with a vehicle floor when the support is in the deployed position.

11. The seat according to claim 9, wherein at least one of the seat panel, the backrest panel and the extension panel on which the support is mounted comprises a cushion, and wherein the support in the retracted position is integrated into the cushion of the panel on which the support is mounted.

12. A seat as claimed in claim 9, wherein the lateral extension system comprises at least three supports, with each support mounted on one of either the seat panel, the backrest panel or the extension panel.

13. The seat according to claim 1, wherein the backrest panel comprises at least one headrest, and in which the extension panel comprises a housing of negative shape corresponding to the headrest, such that in the sleeping position the headrest of the backrest panel is inserted into the housing of the extension panel.

14. The seat according to claim 1, comprising an actuator for moving the seat from the sitting position to the sleeping position and vice versa, with the actuator comprising at least one electrically-operated actuator, and the actuator being supported on one side by the frame and on the other by the extension panel.

15. The vehicle comprising at least one seat according to claim 1.
